(19) United States
(12) Patent Application Publication
(10) Pub. No.: US 2026/0016557 A1
(43) Pub. Date: Jan. 15, 2026

(54) LOCATION SENSOR SYSTEM WITH MULTILEVEL ANNUNCIATOR AND MOUNTING

(71) Applicant: LEXMARK INTERNATIONAL, INC., LEXINGTON, KY (US)

(72) Inventors: AARON GEOFFREY DUNTEMAN, HARRISONVILLE, MO (US); ROBERT WATSON MCALPINE, LEXINGTON, KY (US); ROBERT HENRY MUYSKENS, LEXINGTON, KY (US); BRANT DENNIS NYSTROM, LEXINGTON, KY (US); THOMAS EUGENE PANGBURN, WINCHESTER, KY (US); ERYK ZAGORSKI, LEXINGTON, KY (US); KEITH BRYAN HARDIN, LEXINGTON, KY (US)

(21) Appl. No.: 19/270,335

(22) Filed: Jul. 15, 2025

Related U.S. Application Data
(60) Provisional application No. 63/671,479, filed on Jul. 15, 2024.

(51) Int. Cl. G01S 1/04; G01S 1/68; G01S 19/24

(52) U.S. Cl. CPC G01S 1/045; G01S 1/68; G01S 19/24

(57) ABSTRACT

Described is a sensor that is used to determine the location of an object with additional features that create human-recognizable feedback that identifies an individual object, solving the problem of needing a specialized device to perform the identity step. The location data is sent to Edge or Cloud devices that contain the raw location data. This data has location information that is used to automatically update an Enterprise Manufacturing System (EMS) or other system critical location. This invention integrates multiple location technologies to overcome the limitations of a single method. In addition to updating business systems (EMS), the cloud devices display location data in a multimodal (maps & digital twin) system, allowing operators to visualize and track the movement and location of objects. The combination of coordinated 2D mapping and 3D digital twin representations creates a superior understanding of an object's location and orientation with respect to other objects in its vicinity leading to exact identities within the workflow.

### CROSS REFERENCES TO RELATED APPLICATIONS

None.

### BACKGROUND

### 1. Field of the Disclosure

The present disclosure relates generally to location systems and more particularly to location sensor systems with multilevel annunciator and mounting.

### 2. Description of the Related Art

Location sensors that use RF methods to track assets often face accuracy issues. Most electronic location technologies have inherent errors that prevent them from pinpointing a specific object. While a location device may provide a general area on a map, it typically cannot isolate the specific object.

This technological limitation is compounded by the challenges of human-dependent tracking systems, which are often inconsistent and prone to error. For example, many human-initiated processes involve tracking objects within a system. However, our ability to remember and communicate precise locations is limited. Organizations often rely on personnel to use a standardized system to record the status and location of objects. Problems arise when objects are misplaced or not properly recorded in the system of record. Once an object is lost, significant resources are required to locate the object, update the system, and/or input the information back into the system of record. In many cases, when the missing object is essential for completing a business task, its absence can adversely impact multiple operational processes. To compensate, organizations often maintain excessive inventory, which adds further inefficiencies.

### SUMMARY

In one example embodiment, the present disclosure adds optical and acoustic identification features to allow unique selection of the desired asset. In another example embodiment, the present disclosure creates multimodal indicators using various flashing indicators, color flags or audible sounds at a very low power that satisfies the detection requirements. The advent of low power connectivity, location techniques, lighting and audio systems makes this system possible. Process steps are added that improves usability and battery life. The object location device is coupled with premise and cloud mapping technology that blends mapping technologies with digital twin technologies to create an operations process that brings the data within easy human and machine workflows. The asset being tracked may need to monitor various aspects like temperature, humidity, vibration, or other parameters to guarantee the quality or usefulness of the asset during its location changes.

The system disclosed resolves many aspects of the above problems. Several solutions are embodied. These include a sensor that is used to determine the location of an object with additional features that create human-recognizable feedback that identifies an individual object. This solves the problem of needing a specialized device to perform the identity step. The location data is sent to Edge or Cloud devices that contain the raw location data. This data has location information that is used to automatically update an Enterprise Manufacturing System (EMS) or other system critical location. The automatic transfer eliminates human error and latency of the data. Many systems depend on a single technology to determine location. This invention integrates multiple location technologies to overcome the limitations of a single method. In addition to updating business systems (EMS), the cloud devices display location data in a multimodal (maps & digital twin) system, allowing operators to visualize and track the movement and location of objects. The combination of coordinated 2D mapping and 3D digital twin representations creates a superior understanding of an object's location and orientation with respect to other objects in its vicinity leading to exact identities within the workflow.

### BRIEF DESCRIPTION OF THE DRAWINGS

The accompanying drawings incorporated in and forming a part of the specification, illustrate several aspects of the present disclosure, and together with the description serve to explain the principles of the present disclosure.

FIG. 1 is a diagram showing location system components according to one example embodiment.

FIG. 2 is an example location map with custom overlay.

FIG. 3 is an example location map with sensors and campus highlighted in dashed lines.

FIG. 4 is an example location map with buildings highlighted in dashed lines.

FIG. 5 is an example digital twin map of a building floor.

FIG. 6 is an example of a full building digital twin.

FIGS. 7A-7B is an example flowchart for BLE with optimal energy path.

FIG. 8 is an example signal flow path for LoRaWAN gateway or BLE mesh with gateway.

FIGS. 9A-9B show a representative tag industrial design with features according to one example embodiment.

FIG. 10 is a box or pallet label design with an attached integrated location device according to one example embodiment.

FIG. 11 is a box or pallet label design with a mounting bracket for holding a location device according to one example embodiment.

FIG. 12 is a box or pallet label design with a pallet pocket for receiving a location device according to one example embodiment.

FIG. 13 is an outlet-mounted location device used as an annunciator, anchor, and gateway according to one example embodiment.

FIG. 14 is an outlet-mounted location device used as an annunciator, anchor and gateway covering a wall plate according to one example embodiment.

FIG. 15 is an outlet-mounted location device used as an annunciator, anchor and gateway covering a wall plate with a courtesy outlet according to one example embodiment.

FIG. 16 is a post-hanging location device used as an annunciator according to one example embodiment.

FIG. 17 is a dashboard-applied location device according to one example embodiment.

FIG. 18 shows multiple location sensors on a wireless charging pad according to one example embodiment.

FIG. 19 is a stacked charging station for location devices according to one example embodiment.

FIG. 20 is a stacked charging station for location devices that is free standing according to one example embodiment.

FIG. 21 is a horizontally stacked charging tray according to one example embodiment.

FIG. 22 is a location sensor anchor point gateway with double plug in and out according to one example embodiment.

FIG. 23 is a wall-mounted stackable charging station with a drop-in top according to one example embodiment.

FIG. 24 is an exploded view of the wall-mounted stackable charging station shown in FIG. 23.

FIG. 25 is a desktop-mounted stackable charging station with drop-in top according to one example embodiment.

FIG. 26 shows location tags that are different sizes for complementary functions according to one example embodiment.

FIG. 27 shows a strap-mounted location device strapped to a wheelchair according to one example embodiment.

FIG. 28 shows a strap-mounted location device with a printed label slot for customization according to one example embodiment.

FIG. 29 shows example dimensions of a strap-mounted location device according to one example embodiment.

FIG. 30 illustrates an example mobile location device through AP and anchor space according to one example embodiment.

FIG. 31 illustrates a 3D digital twin of a building where the location sensor can be located within the space according to one example embodiment.

FIGS. 32A-32B are flowcharts for operating a location sensor when the location sensor is powered for the first time according to one example embodiment.

FIG. 33 is a flowchart for operating a location sensor when the location sensor awakes due to a timer according to one example embodiment.

FIGS. 34A-34D show sensors with color and light flashing indicators according to one example embodiment.

FIGS. 35A-35C show sensors with color and light flashing indicators on a curved sensor according to one example embodiment.

FIG. 36 shows an example landing page of a user interface according to one example embodiment.

FIG. 37 illustrates a campus level experience highlighted with a left pane sensor list and dots for sensors on the map according to one example embodiment.

FIG. 38 illustrates a building level highlight that represents a digital twin of a building according to one example embodiment.

FIG. 39 illustrates a combination GUI with sensor tree, sensor graph data, 2D map and 3D digital twin according to one example embodiment.

FIG. 40 is a flowchart for user experience according to one example embodiment.

FIG. 41 illustrates a cold chain two-part shipping container according to one example embodiment.

### DETAILED DESCRIPTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

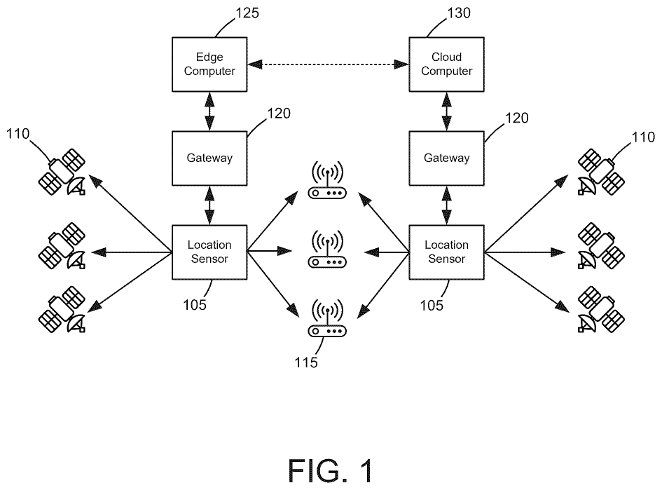

FIG. 1 shows a system for location sensors 105 to receive Global Navigation Satellite System (GNSS) signals from satellites 110 for geolocation when the sensor is outdoors or receive signals from Wi-Fi access points 115. When outdoors, the GNSS signals are received well because there are no obstacles overhead to block the signals. Buildings or cover structures can reflect or absorb GNSS signals, keeping the sensors from finding a location.

Many locations have Wi-Fi systems that may be in close proximity to the location sensor. These signals can be an alternative method to determine a location. If the Wi-Fi access points have known locations, then the signal strengths and MAC addresses can be used to calculate the location sensor's location.

The location sensor 105 is an electronic device with a CPU and radio system able to receive satellite or Wi-Fi signals. The satellites 110 emit a signal that the sensor uses to determine the time of flight, and the position of the satellite is used to determine the sensor's location. Wi-Fi 115 emits a signal to advertise what networks are available that include the MAC address in the metadata. This is used to determine the location by analyzing the signal level RSSI and knowing the location of the access point.

Bluetooth or BLE (Bluetooth Low Energy) radios can also be used to determine location of tags by having anchor devices with known locations and the signal strengths.

Today's GPS sensors calculate the location directly from the satellite, but this is a power intense method that discharges batteries quickly. To reduce the power used, raw data is sent from the location sensor 105 to a gateway 120 that uses networking methods to communicate to a computer device that is connected to a power system. The computing system can be an edge computer device or server 125 at a premise location. This system can be either connected to the internet or isolated from any external systems. It is also possible to have edge computers to communicate with cloud computer systems 130 to keep long term records, backups and give directions to the edge computer.

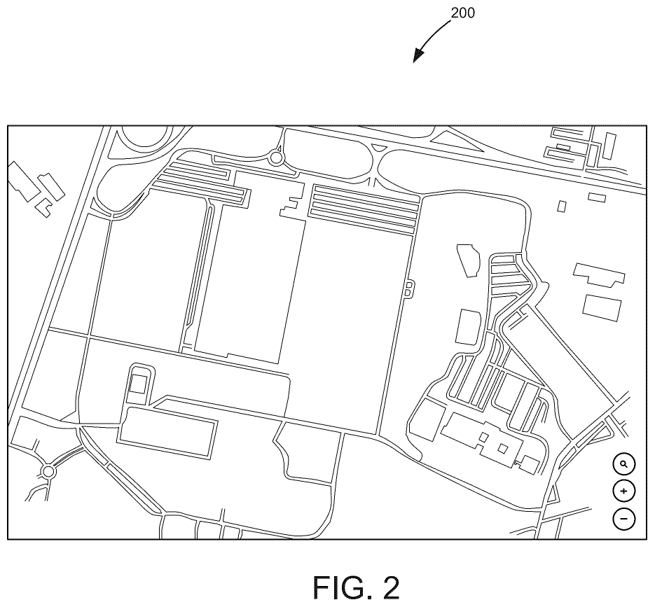

Location information is best described in spherical or linear coordinate systems that are difficult to process by a human since they have no real frame of reference associated with them. The easiest way for humans to process location data is using a mapping system. FIG. 2 shows an example mapping system 200 with a custom map overlay to represent private property features. Most modern map systems have minimal detail when displaying private property. In the example shown, the map includes CAD drawings that add the desired details which can include both outdoor and indoor features that include structures, parking lot line, roads, structures, and buildings. Buildings need representation of rooms, isle ways, dock areas, restrooms and mechanical areas.

One of the limitations of 2D mapping solutions is that they do not represent a 3D space for objects that may not be on a floor plan. For example, objects that need to be tracked may be elevated overhead or even above ceiling tiles for HVAC equipment. In a manufacturing building, there may be overhead conveyor systems at multiple heights. To more accurately represent the elevation of objects to be tracked, a 3D digital twin model has been created to augment the mapping functions. Existing 2D maps and 3D digital twin technologies exist separately; creating user difficultly navigating between a larger map and zoomed in 3D building or facility experience.

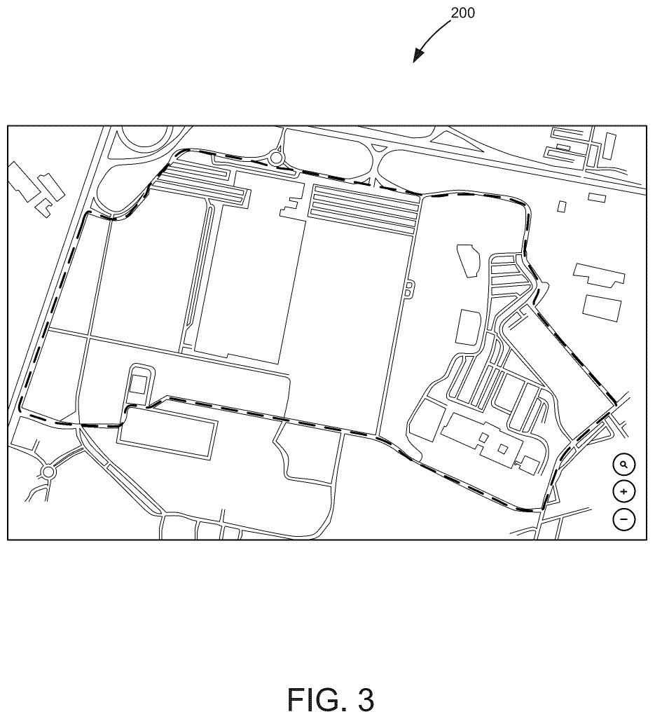

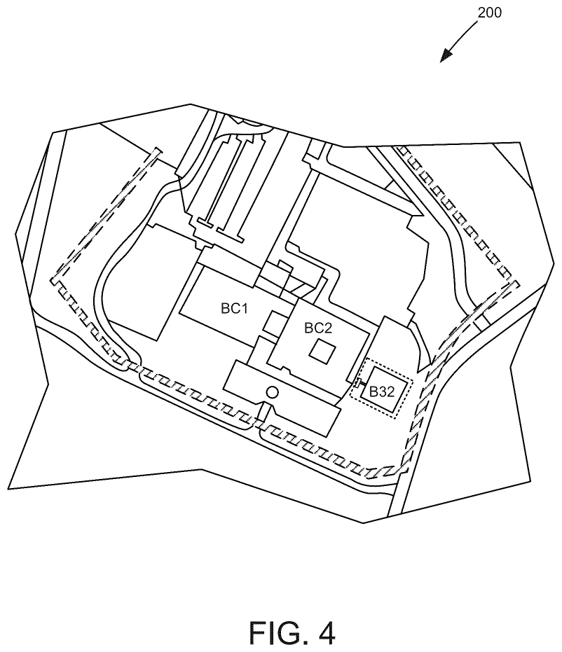

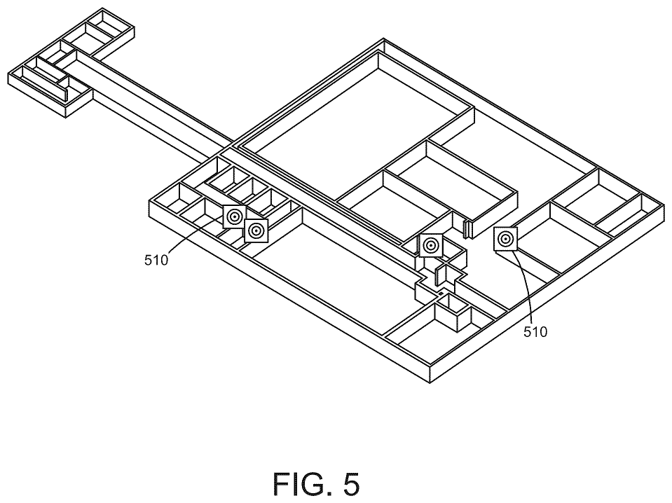

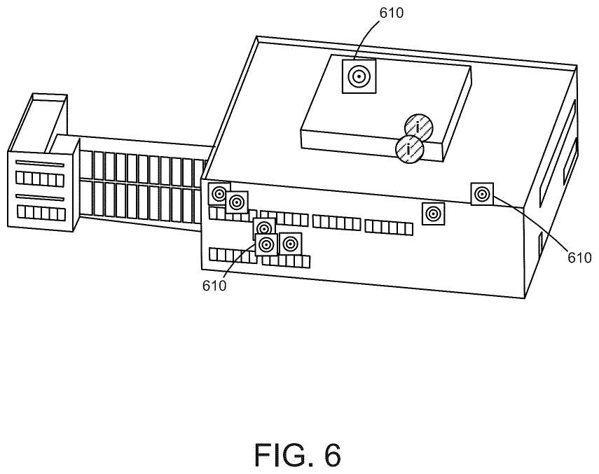

FIGS. 2-6 show representations of the 2D map with various zoom levels. FIG. 3 shows a 2D map, zooming in to a campus highlight with a perimeter highlighted. FIG. 4 shows a 2D map with a building B32 highlighted. FIG. 5 is a map created by using a cut through just above the first floor that creates a map showing the 3D aspect of furniture in offices with walls, doors, and columns. FIG. 6 shows the same building with some exterior walls, doors, and roof removed. This exposes the view so that important objects can be viewed. The glyphs 510, 610 (shown as boxes with circles inside) represent sensors 105 that have their telemetry available within the edge or cloud computer systems.

The location map custom overlay in FIG. 3 shows a traditional map with private property boundaries and internal property areas that provide the user location specific context for the objects being tracked. The map in FIG. 4 shows a 2D map with building boundaries highlighted for easy recognition. The section shown in FIG. 5 can be in any plane direction to show the view with any cross section that exposes the desired locations within the building. The view can also be first person that represents what a person would see from inside the building. The building in FIG. 5 is the same shown in the dashed line within FIG. 4. Note that the current art does not couple the operational characteristics of the 2D and 3D maps within a workflow.

A location sensor 105 may be placed on any object and represented on a map or within a digital twin. The location sensors 105 typically have the said global positioning system (GPS), global navigation satellite system (GNSS) or Wi-Fi sniffing used to determine the location coordinates. Many of these will have small light emitting diodes (LED) to indicate that the sensor is working or transmitting data.

Embodiments of the present disclosure provide additional features to location sensors/devices 105 that enhance their capabilities to solve several problems. For example, location devices typically do not have the accuracy to identify a particular object. This problem scales by the relative size of each object versus accuracy. Another related problem is that personnel tasked with moving objects may not have a human machine interface (HMI) device that identifies the object uniquely. The present disclosure puts together a radio that receives GPS, GNSS and Wi-Fi signals to transmit raw data to a location calculation engine. Alternatively, the calculation engine may also be implemented in the sensor. Another problem is that the location data must be visualized in a 2D and 3D context to which the user can quickly relate and correlate to their real-world environment. This visualization includes a 2D map and a 3D digital twin, and devices being tracked show up in both the map and digital twin environments.

The map can show generally where an object is at, but the objects may have many other objects that look the same and need to be uniquely identified. For example, the location sensor 105 may be applied to people, pallets, fork trucks, hospital equipment, wheelchairs, beds, computer towers, cars, trucks, trailers, construction equipment big and small, tools, printers and a large range of other products.

In another example embodiment, the location sensor 105 includes a flash indicator that can be seen in full sunlight. One method is to use a high-power LED that is pulsed with minimum wattage of 0.5 Watts. An alternative would be to use a Xenon bulb flash. These flash lighting methods can be integrated into the location sensor 105 or be a plug-in option.

Location sensors 105 are typically battery operated so minimizing the power is critical for extending the battery life. Below are example schemes that work with the location sensor 105 to minimize power usage according to example embodiments of the present disclosure.

In one example embodiment, for a location sensor 105 having the mentioned GPS (GNSS) and Wi-Fi sniff for location determination, a light annunciator may flash for a duration greater than 0.1 second but less than 1 second. This is to be long enough to be visible but short to conserve power. This duration will be adjusted depending on the ambient light.

In another example embodiment, a photovoltaic cell can be used to help power or charge the batteries for the sensor and the voltage from the cell can be used as an indicator of the ambient light. This is then used to adjust the duration of the pulse to be visible and conserve power. An alternative to photovoltaic cell is to use a photo diode to measure the amount of light and adjust the light power. The flash frequency can also be adjusted to make the location of the sensor more obvious with a rate between about 1 second and about 20 seconds. A flash frequency of 1 flash for every 10 seconds is long enough to reduce the power used but often enough to allow an operator to move from a distant location.

Another example embodiment provides a combination of LED and Xenon lights that flash. This is to enhance the speed and distance of recognition for recognition at a longer distance outdoors in full sunlight. In this embodiment, the Xenon flash rate is extended to 20-30 seconds with a best mode of 25 seconds. The LED can then flash at a 1-10 second rate with a best mode of 5 seconds. In this embodiment, if the ambient light is low then the Xenon flash can be eliminated and the LED flash can be set to 1-20 seconds with a best mode of 10 seconds.

Another example embodiment uses a lighting device that is capable of variable on-time control or flash durations to distinguish between different types of alerts. For example, the lighting device can communicate a character using Morse code. For six different combinations, a short light duration may be a dot, and a substantially longer light duration may be a dash. With 2 light flashes, 6 different states can be easily communicated using Morse code. For example, the letter E is a single dot (.) and the letter T is a single dash (-). Expanding, then A is a dot dash (. -), N is dash dot (- .), I is dot dot (. .), and M is dash dash (- -). These are the best modes for 6 states that minimize the power draw depending on the dash time. The next letter would be S with dot dot dot (. . .) and H with dot dot dot dot (. . . .) that expands to 8 states.

The flash for location may be initiated when a supervisory system requests that an object be moved by a human or robot that will be looking for the flash to uniquely identify the object to be moved. The supervisory system will calculate the travel time for the person to move from the current location to the vicinity of the object to be moved. A message will be sent to the location device 105 to schedule a flash to start about the time the moving person would be in sight of the location device 105. This will minimize the flash time interval from the start of the process.

In another example embodiment, the process may turn the flash off as fast as possible. An accelerometer, gyroscope or magnetometer may be present on the location device 105. Any of these devices can detect when the object is being moved. This movement will be detected by the location device 105 and the flash can be turned off after a delay period. The delay is for situations where the object to be moved may have other items stacked on it and may shake as a part of isolating the object to be moved. If the detected movement is continuous, such as between 10 to 60 seconds with a best mode of 20 seconds, then the object is considered to have been identified and is being moved. The flashing can then be stopped to save the battery life. If there are any reasons to start the flash again, then the supervisory system can send the flash request again. As another embodiment, the sensor can be geofenced so that when the sensor location moves beyond the fence, then the flash can be turned off.

In another example embodiment, the location sensor 105 may utilize e-ink or e-paper (electronic paper) technology for a display which uses very low energy to operate. E-ink is a low power technology that can support black, white or multiple colors. The size and lighting can affect the distance to resolve the color. The location sensor 105 may display a full panel of color representing the status of the sensor's object. White may represent that the object is in its expected location, black may represent that the object is not where it should be, and red may indicate that the object is to be moved. An E-ink display can also display human readable text so when an operator is close, the object status and contents may be displayed. Note that E-ink displays need ambient light to make the display useful. For this reason, the said lighting system will still be useful for low light conditions or when distance is a problem.

In another example embodiment, the photo diode that is sensing ambient light may be positioned within the view of the flashing devices on the location device 105. This sensor can then measure the light output of the flashing devices as an automatic self-diagnosis method for the flash operation.

Another example embodiment uses the flash of an external device that is detected by the photo diode on the location sensor 105 to acknowledge the identification of the object to be moved. This would shut off the flashing of the location sensor. A phone application would send a sequence of flashes to be a key pattern to shut off the flashing light. It is likely that multiple location sensors 105 are energized to flash at one time. In this case, the location sensor 105 can be programmed to have different flash rates and sequences to identify different objects. The turn off sequence will be unique for each sensor so that the wrong sensor is not turned off.

Another example embodiment works to overcome limitations when the location sensor 105 is located in bright full sunlight. In this embodiment, the location sensor 105 may include a window where a disk or drum is rotated to reveal a solid color. For example, a disk can be divided into three pie slices each having the same area. The colors should be very different in appearance so that they can be easily distinguished. For this example, the colors are red, green and blue. Each color will correspond to an action needed. The green color will be revealed through the window when no new action is needed and can be the default state. The red state could indicate that some repair or maintenance is needed. For a battery-operated location sensor, the red state may indicate that the batteries are getting low and should be replaced when possible. The blue color may indicate that the object that is associated with this tag needs some type of action. This kind of mechanical system can be done with low friction and minimal energy. Additionally, the body color should be a very different color to create a strong contrast to the colors used on the indicator device.

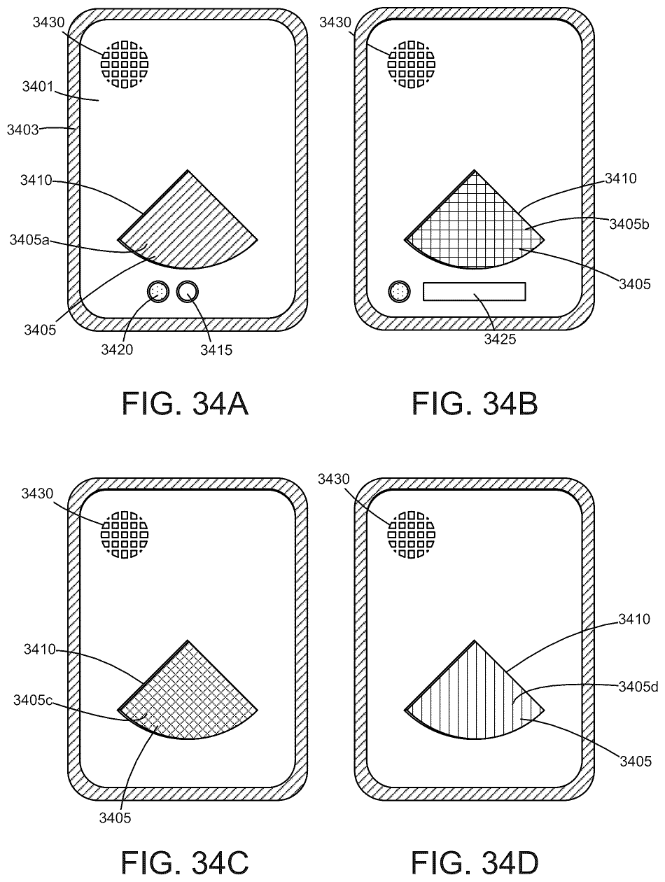

A high contrast background also helps a person visually identify a sensor when located on an object. This will bring quick attention to the sensor, and then the flashing light or color window can be easily seen. For example, FIGS. 34A-34D show a design where the body color 3401 is bright (e.g., yellow) with a dark surround color 3403 (e.g., black) that creates the general device contrast. Then the color wheel opening has multiple colors, such as red, blue, green or black. Any three of these may be selected for the 3-color set. This example is not limited to 3 colors. The window could be half circle and only two colors used. More colors can be used if the pie slice size is reduced. Also, more states can be generated if two different colors are shown in the window at one time. The 3-color wheel can easily be used to show 6 states.

In FIGS. 34A-34D, different colors 3405a-3405d on a wheel 3405 that spins is used to indicate different states of the sensor. The window 3410 that the wheel shows through is one third of the wheel 3505 for each color. The window size can be one half or one quarter of the wheel space. This would allow more states to be shown but each would be smaller in size for the higher number of color slices. FIG. 34A shows first color 3405a (e.g., a red color) in the window 3410. An LED 3415 is shown at the center bottom to indicate that action is needed when the ambient light is not sufficient to see the color indicator. The circle 3420 to the left of the LED 3415 is a photo diode that can measure both the ambient light and the light level of the LED. When the photodiode measures the ambient light, it will determine when the LED is needed to illuminate the sensor or that the ambient light is sufficient to indicate the action. The LED is oriented in close proximity to the color wheel 3405 to illuminate the color for the action needed. The second sensor shown in FIG. 34B shows a xenon light bulb 3425 that is used when a brighter flash is needed compared to the LED.

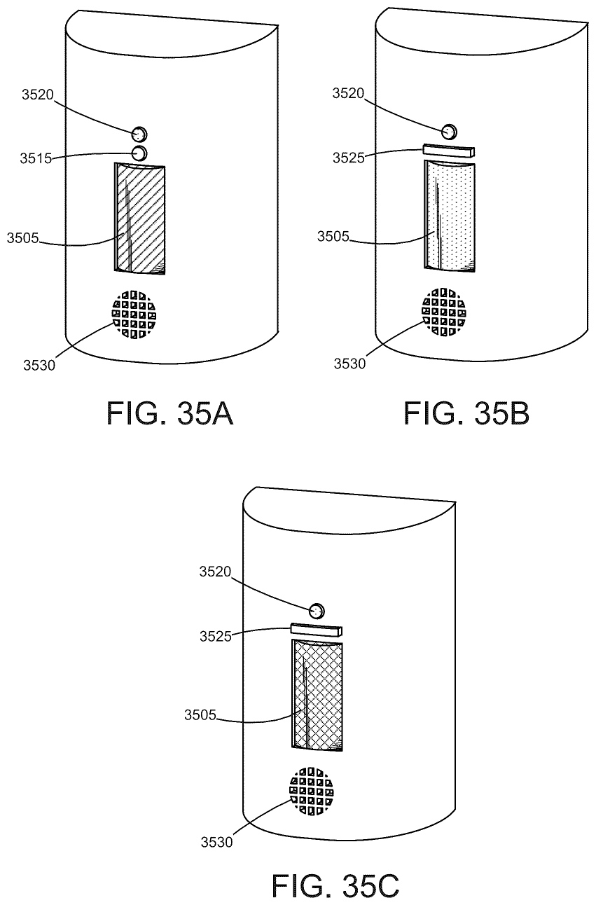

FIGS. 35A-35C show a similar design as FIGS. 34A-34D but with a half cylindrical shape. The color wheel 3505 in this example is a cylinder that rotates around the vertical axis. The cylinder shape allows the location sensor 105 to be seen from a wider range of angles from an observer point of view. In the embodiment illustrated, the LED 3515 and photo diode 3520 are on a curved surface. This makes it easier to see when the observer is at a right angle to the face of the location sensor. Different location sensors 105 are shown with xenon flash bulbs 3525 as well.

Each of the embodiments shown FIGS. 34A-35C also shows speaker openings 3430, 3530 with a circle with slots. This allows the sounds from a pulsed tone to be emitted from the location sensor.

Another embodiment uses a combination of Long-Range Wide Area Network (LoRaWAN) and Bluetooth Low Energy (BLE) to send a backhaul message to a network. Locations devices can communicate using LoRaWAN or BLE, and choose the lowest energy method to perform each communication. The firmware for the location device 105 has a metric for the power used for each transmission via LoRaWAN or BLE. This data is sent as part of the metadata for the uplink payload. The network can then analyze and advise the location sensor 105 through the downlink of which method to prioritize the data to be sent. This method will be applicable for peer to peer or mesh BLE operation modes. LoRaWAN operates via a star topology so that any location device 105 may send an uplink that is received by any gateway within range. The gateway with the strongest signal is then selected as the path to be listened to. Any downlink then uses that path to send the response.

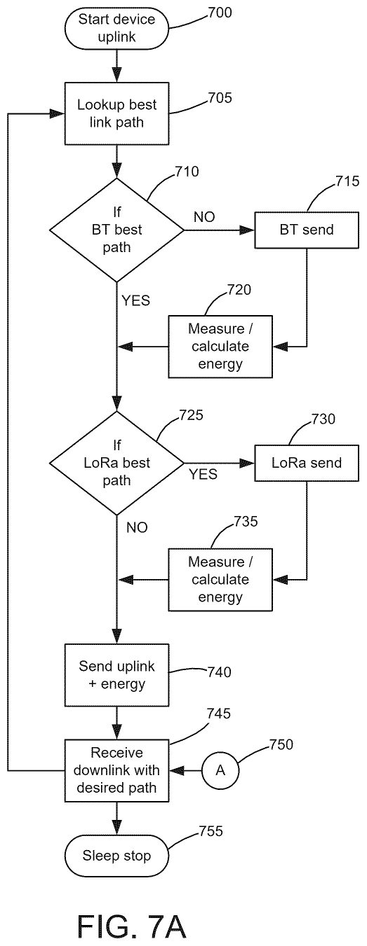

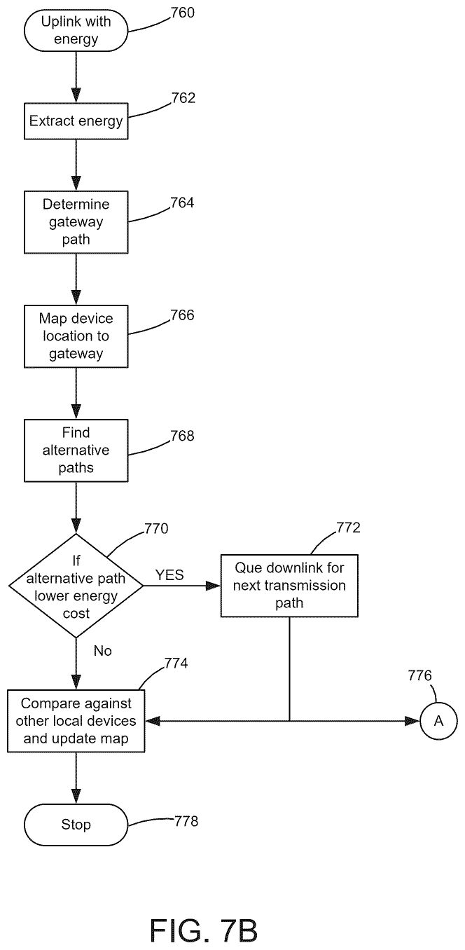

FIGS. 7A-7B is an example flowchart for determining whether a Bluetooth or BLE communication path is deemed to be the lowest energy path. The combination of LoRaWAN and Bluetooth Mesh gives the ability to combine the communication and functionality of both technologies. Devices with both Bluetooth Mesh and LoRaWAN are configured to decide which communication path to use and what data to send out. The power usage and gateway paths are used to decide the connectivity method. Generally, a sensor determines an event for action and sends a value directly to an actuator via BT and no data is required to be monitored to the right then no additional communication is specified. If a device is out of range of a BT Mesh, then the LoRaWAN path is used. If a device is within range of BT Mesh and data is required to the right, then a proxy gateway will transmit the data. There are two proxy situations: a) There is a BT gateway that has a backhaul method to the right then this is preferred; b) If no backhaul exists the proxy uses LoRaWAN to transmit the data. If the device is BT Mesh connected but power is optimized by LoRaWAN for right level, then use LoRaWAN.

In FIG. 7A, the device uplink is started 700, next device looks up the best link path 705, which is either Bluetooth (“BT”) 710 or LoRaWan 725. In either case a signal is sent 715, 730, and the energy of the respective signals is measured 720, 735. The power usage and gateway paths are used to decide the connectivity method. The uplink and energy are sent 740 and received in FIG. 7B, 760. The energy measure is extracted 762, and the gateway path is determined 764. The device location is mapped to the gateway 766. Alternative paths are found 768 to determine if any alternative path has lower energy costs. If so, then the downlink for the next transmission path is selected 772, otherwise the path is compared against other local devices and the map is updated 774. The result is returned at “A” 776, FIG. 7B; 750, FIG. 7B, and thus the downlink is received with the desired path 745. Thereafter, the device returns to determine the best path for the next uplink or sleeps 755.

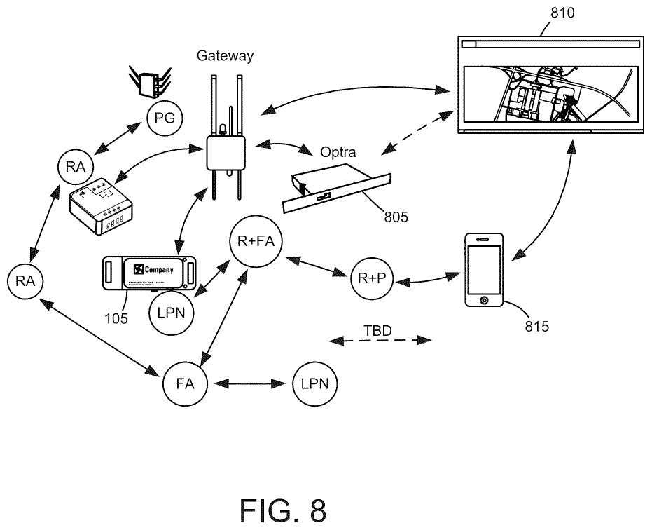

FIG. 8 shows the possibilities of signal flow between devices in the networks from the location sensor 105 device through a LoRaWAN gateway to premise or cloud devices or via a BLE mesh or directed mesh device path. Optra 805 is an edge computer that can resolve and retain the location information as a premise device. The map browser 810 represents a cloud computer that can also resolve and retain the location information. The phone 815 shown can be a gateway device to the BLE mesh and can connect to the cloud through cellular providers and the internet.

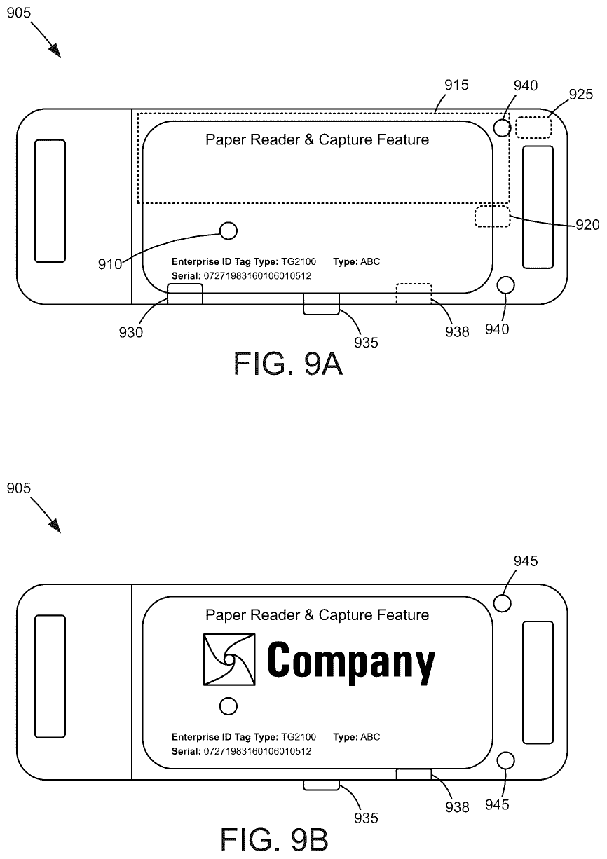

The sensor that shows with the “Company” logo in FIGS. 9A and 9B is one form factor that the location sensor 105 can use. FIGS. 9A and 9B show features that are built into a tag 905 comprising the location sensor 105. In the example shown, the tag 905 is rectangular shaped and can be applied to an object using adhesive, magnet, suction cup, hook, clip or screws. The tag 905 has any combination of GNSS/GPS, Wi-Fi sniff, BLE or UWB locations technologies. The backhaul may be LoRaWAN, Wi-Fi, Bluetooth (BLE), UWB or cellular to transmit the telemetry to a premise or cloud system. The tag may also have accelerometer, gyro, magnetometer, temperature, humidity, photo diode or contact switch sensors used to operate internally or transmit the data to an advisory system. The tag may use single use or rechargeable batteries. Recharge can be accomplished using a photovoltaic cell or plug in external power via a connector. The best mode connection for charging and modifying the settings or firmware is a USB connector. The connector has a waterproof cover for outdoor operation.

A mechanically operated switch 910 is used to detect when the location sensor 105 is mounted to a surface. This is used to alert the supervisory system if the sensor was removed from the object it is tracking. The paper capture feature 915 is a cavity where printed paper or similar material can be inserted for human readable information. The clear cover of the paper capture feature can be hinged or fixed. The paper release button 920 is used to open the cover or retract a friction pad holding the paper. A rectangular pocket 925 creates a Kensington lock positioned to attach the location sensor 105 to the cabling system. The sensor has a transparent plastic or glass area used to transmit light in or out of the sensor. The LED, Xenon, laser, neon, or other light method is used to indicate that some action is needed for the sensor or the object that the sensor is associated with. The glass area can be used to receive light to a photo diode to determine ambient light level used to determine the flash brightness or duration as previously discussed.

The location sensor 105 (tag 905) has a button (such as a recessed call button 930 or a pronounced call button 935) that is easily accessible to be a call or response button that indicates an operator needs to initiate or respond to a task. For example, if the location sensor 105 is flashing the light indicator, then the object may need to be inspected or moved. If the operator presses this button, then the advisory system is advised that a person is at the object to perform the task.

The recessed button 930 is designed to require additional effort to activate. This button is used for actions or tasks that are rare and would not want to be accidentally pressed. For example, if there is an emergency or situation that needs immediate action this would be the button for that task. Another function could be to perform a hard reset that causes the sensor to revert to the factory settings. Another operation would be to prepare the location tag for a firmware update to be accepted through the USB connection 938. When the location sensor 105 has a rechargeable battery, contact posts 940 are located on the surface to receive power and data connection when desired. The connections on the back side are to receive the incoming power. An additional feature has posts 945 on the top side that are spring loaded to allow power and data to pass through the location sensor 105 to allow stacking, charging and data transfer to multiple sensors at one time.

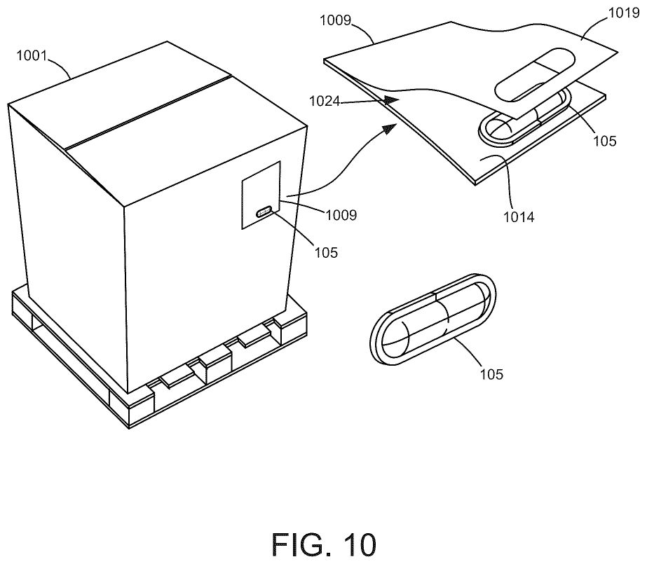

FIG. 10 shows a box or pallet container 1001 with a combination of a location sensor 105 (tag) that is attached to a folded or partially laminated mylar or plastic bendable material 1009. The location sensor 105 is affixed to the inner layer 1014 and the outer layer 1019 folds over the sensor and latches into place. The cavity 1024 created by the layers is used to house a human readable paper layer captured by the locking mechanism of the top plastic layer.

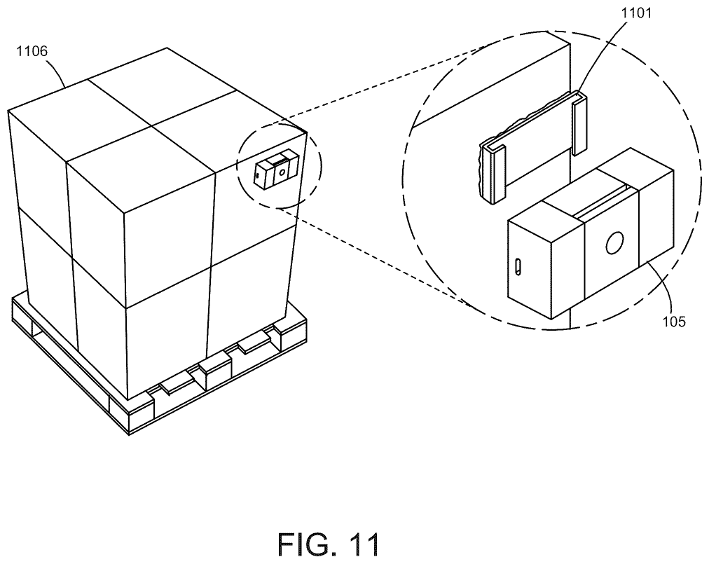

FIG. 11 shows a similar configuration as FIG. 10 with a mounting bracket 1101 that is affixed to the boxes on a pallet 1106. The mounting bracket 1106 has a snap locking mechanism that holds the location sensor 105 (tag) with a key slot to be inserted that holds the system together. The key slot on the tag may be replaced with a spring action loaded button that extends into the mounting bracket.

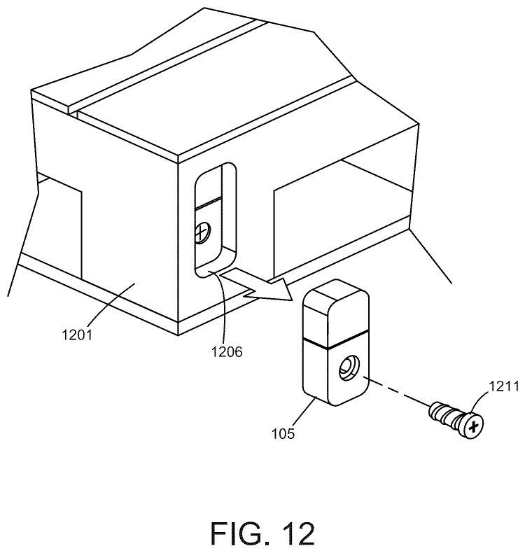

FIG. 12 shows a location sensor 105 (tag) mounted into a recessed area 1206 of a pallet 1201. Pallets receive many impacts from fork truck and pallet jacks over the course of their lifetime. A recessed pocket protects the sensor from these impacts. In this figure, a screw 1211 is used to mount the sensor. This could be replaced with a key, pin, nail, or snap to hold the tag in place.

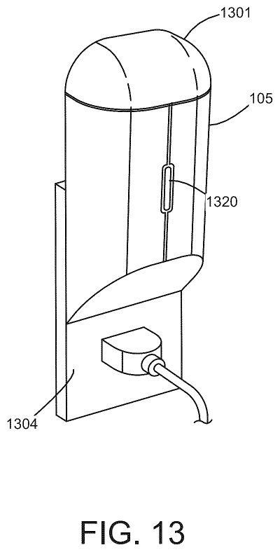

FIG. 13 shows a location sensor 105 used as an anchor device 1301 that plugs into a power outlet 1304. This location tag has multiple purposes and features. It incorporates most of the features found in that include the lighting area for flashing or night light indicator. The clear or transparent cover areas also have a photo diode that is used to determine the ambient light. The same photo diode can be used to calibrate or monitor the light output. The button 1320 in the front can be used to acknowledge or create a call condition. The button can have two levels of action. A partial push starts the call action but a deeper push or longer push can activate the rarer events. This location sensor 105 is typically stationary, but the location features allow for automatic location detection as part of the commissioning process. At times these anchor points may be moved to allow better operation due to the proximity to other devices that are connected into the same system. This anchor device also may have LoRaWAN, Wi-Fi, Bluetooth (BLE) or cellular connectivity. This anchor device's known position can then monitor other devices with the signal strength and meta data to localize the other devices. For example, BLE functionality includes signal strength and MAC (unique identifier) that is used to estimate the distance from the anchor points for trilateration between 3 or more anchor points. Ultra-Wide Bandwidth (UWB) is another technology that uses time of flight to determine the location of a device. This may be incorporated into the anchor point and other devices to find their positions.

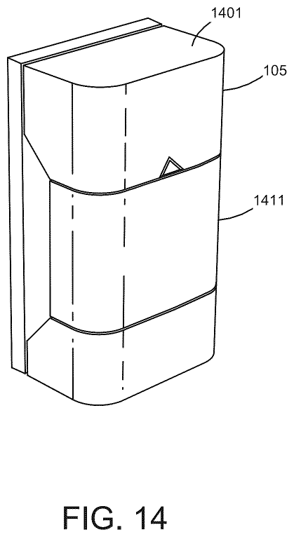

In FIG. 13, the anchor device can be removed from the power plug without any tools being necessary for easy reassignment to another location. This can cause problems in some environments where devices may be stolen or moved that will affect the operation of the system. In FIG. 14, a location sensor 105 used as an anchor device 14001 has been redesigned with a different industrial design that covers the outlets and has a mounting screw feature that allows a screw (not shown) to be used to hold the sensor in place. The cover 1411 may be locked or require a special tool to remove the cover to get to the mounting screw. The design intentionally covers the outlets to keep other devices from being plugged into the same outlet. This will reduce the probability of the anchor being removed.

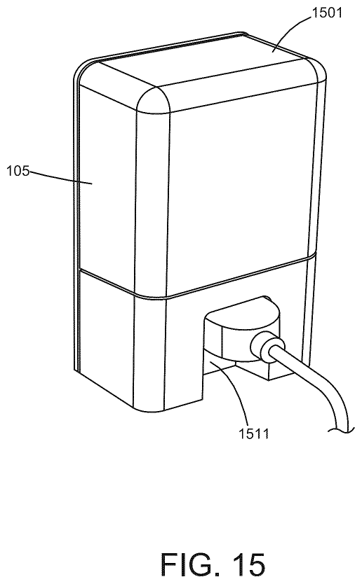

In FIG. 15, a location sensor 105 used as an anchor device 1501 has a pass-through outlet 1511 to allow another device to be connected to the same outlet.

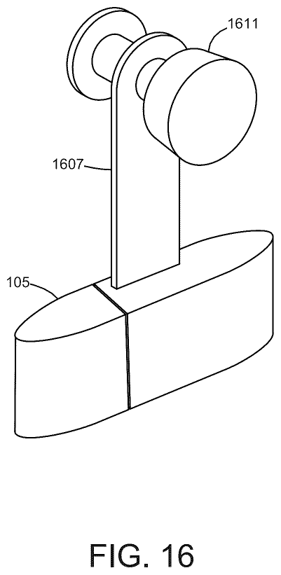

Many devices that are mobile in nature like plastic injection molding tools, electric motors, internal combustion engines and other devices may be too hot or have extreme vibrations that can interfere with a location sensor's operation. In cases like this, FIG. 16 shows a location sensor 105 that is mounted with a strap or tether 1607 between the object to be tracked and the location sensor 105 device (tag). The post 1611 shown is mounted onto the object to be tracked. The strap 1607 is selected to have the strength and thermal isolation to allow correct operation of the object being tracked and the senor.

FIG. 17 shows an industrial design for a location sensor 105 tag to be placed on the dashboard 1701 of an automobile or truck.

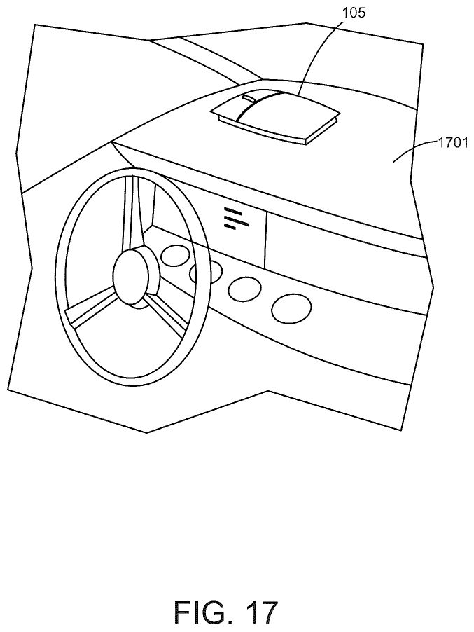

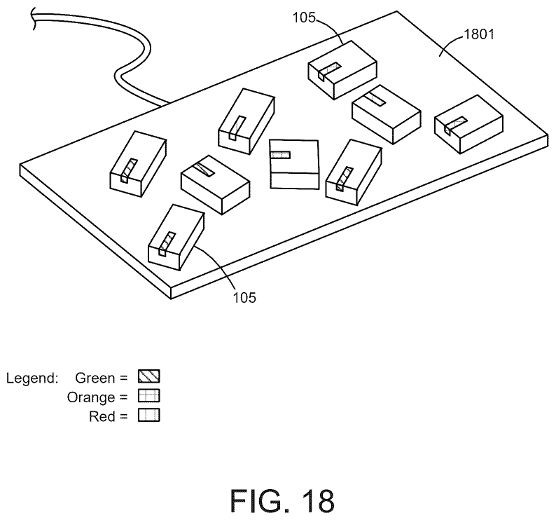

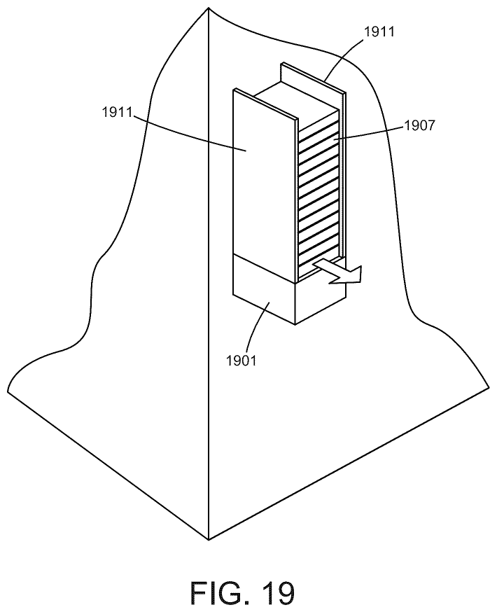

The location sensor 105 (tag) may be designed with single use or rechargeable batteries. This includes the possibility of charging by different methods. FIG. 18 shows a magnetic field method to charge sensors 105 that are placed on a pad 1801. This near field method is similar to those used with mobile phone charging. FIG. 19 shows a vertical charging system with the charging system 1901 at the bottom of a stack 1907. The charging posts 945 shown in FIGS. 9A and B contact the charging power supply at the bottom. The pass-through posts then contact the next sensor in the stack. The system is designed to put the last recovered sensor for charging and place it on the top of the stack. The sensor at the bottom of the stack has been in the charger the longest so it is the first to be removed for the next use. FIG. 19 has walls 1911 that locate the devices in their correct location so that the charging posts will be aligned.

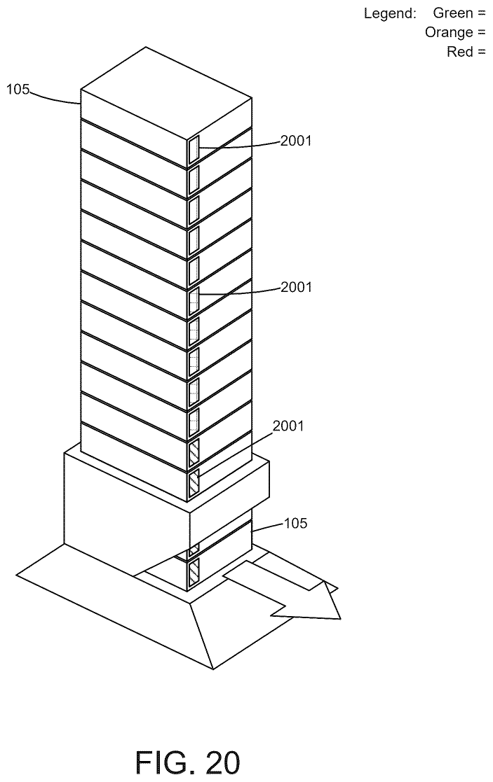

FIG. 20 shows a stacking method such that the sensor has features that self-aligns with the tags that are already in the stack. Again, the bottom sensor 105 can be removed, and the sensors drop down due to gravity and realign for continuous charging. An input funnel can be changed for mother or slave tags. The status indicator bar 2001 shows charge level. In one example, the tag tower is magnetically connected together and charged tags pull from the bottom.

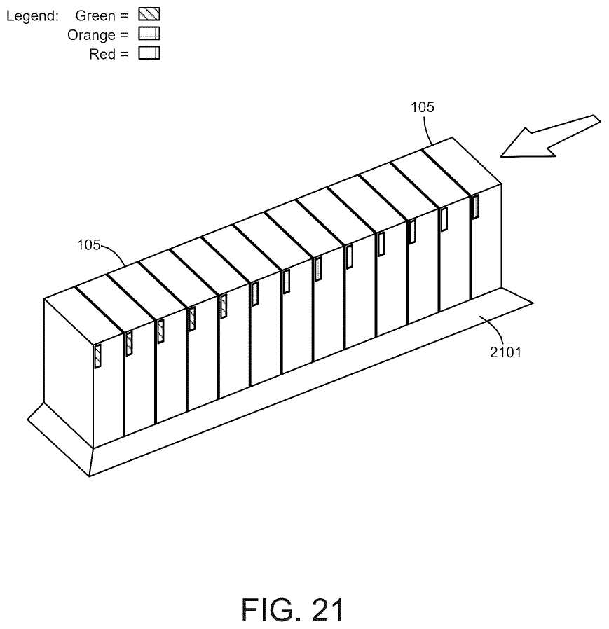

FIG. 21 shows a charging station that has the sensors 105 stacked horizontally on a charging tray 2101. This horizontally stacked charging allows horizontal translation on a first in last out basis. The design has power and data rails (not shown) that connect to the edges of the sensor. The charged sensor is pulled from the left side of the figure. The sensors are pushed to the left from the right side to add the least charged on the right side of the figure.

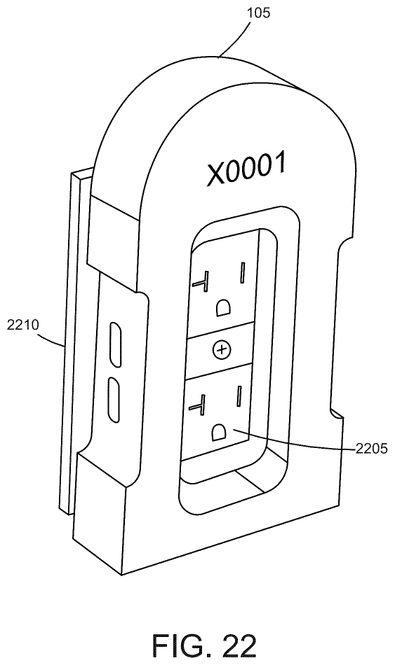

FIG. 22 shows another industrial design where the sensor 105 becomes the wall plate for an outlet cover 2205. A back plate 2210 is removable that has the outline for the outlet shape. In this design, the sensor is wired into the outlet box bringing power to the location device 105. The existing outlets are allowed to be used by plugging through the sensor. This retains the use of both outlets without incurring the cost of duplicating the outlets.

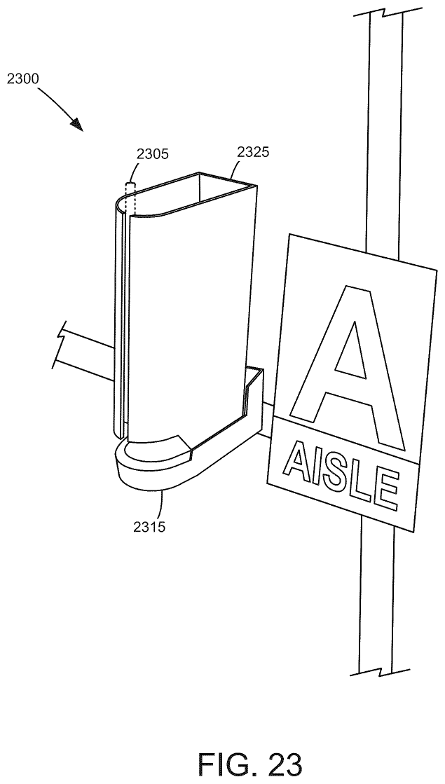

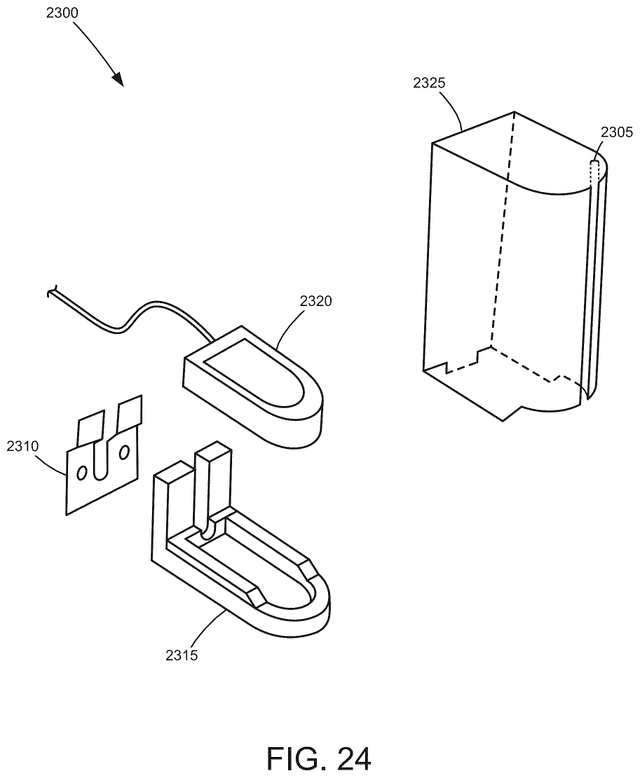

FIG. 23 shows a wall-mounted industrial design of a charging system 2300 for charging location sensors 105 that is very similar to the design shown in FIG. 19 but with a gap 2305 in the front of the wall system. FIG. 24 shows the components of FIG. 23 separated to give a better understanding of how the system fits together. In the embodiment shown, the charging system 2300 includes a mounting bracket 2310 attachable to a surface, a base 2315 that is attached to the mounting bracket 2310, a charger 2320 that is positioned on the base 2315, and a tag funnel 2325 for receiving a stack of location sensors 105. The gap 2305 allows a person's fingers to hold the sensors while lowering them into the stack. This solves the problem of dropping into the top and having them orientating themselves and not flipping or misaligning the stack.

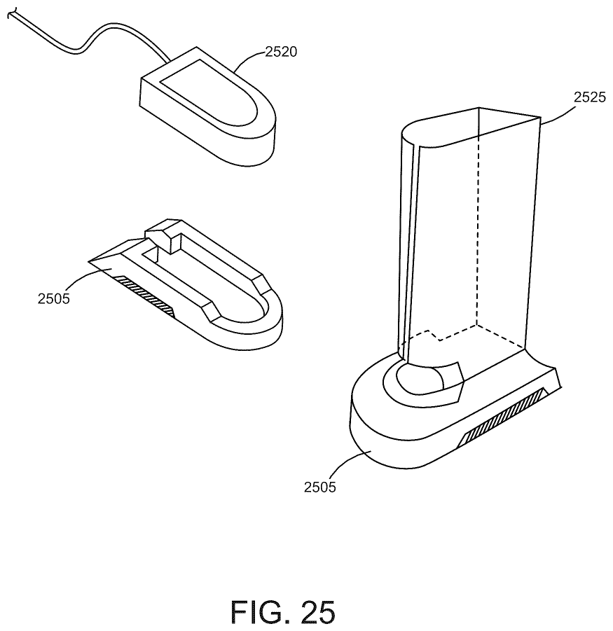

FIG. 25 shows the system in FIGS. 23 and 24 with a different base 2505 that allows for a freestanding tabletop implementation using most of the same elements but with a larger base with the foot print area to make a stable stand. The charger 2520 and tag funnel 2525 are the same as the charger 2320 and funnel 2325 shown in FIGS. 23 and 24.

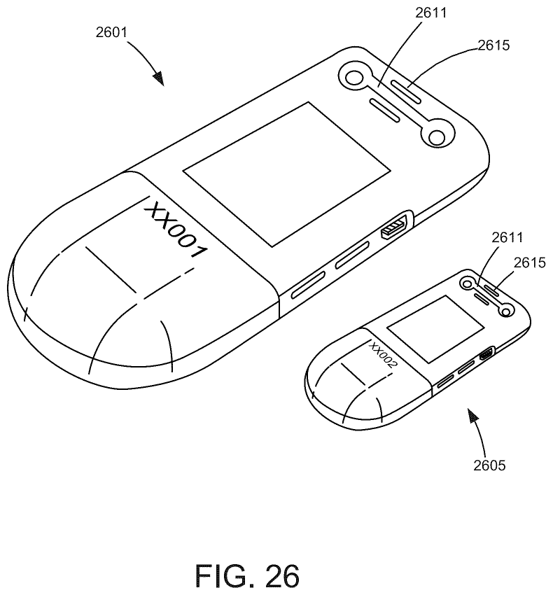

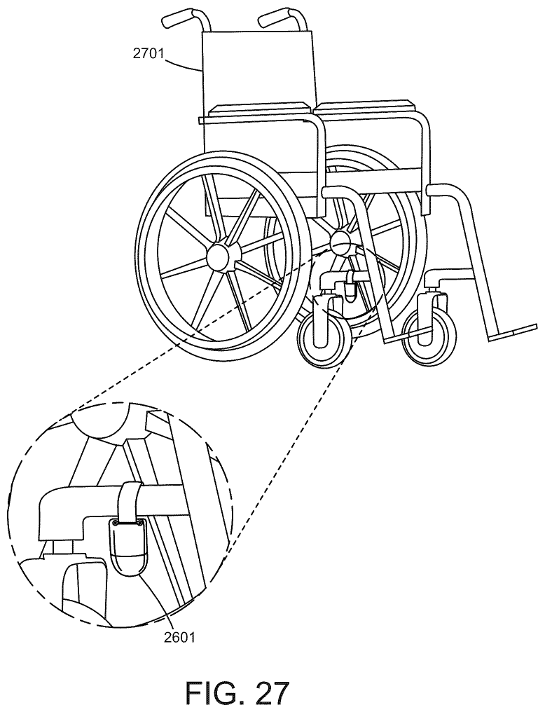

FIG. 26 shows another industrial design that has the same functions as the example described with respect to FIGS. 9A and 9B for the controller tag 2601. The satellite tag 2605 is much smaller in size but has limited functionality. For example, the satellite tag 2605 may only have Bluetooth (BLE) connectivity but can establish a link to the controller tag 2601 as long as they are in range of each other. The lower functionality then requires less energy so that the battery may be smaller as well. The controller tag 2601 may be mounted to a wheelchair or walker device so that it is not heavy for a person that needs these devices. FIG. 27 shows how the controller tag 2601 in FIG. 26 may be strapped to a wheelchair 2701. The person using the wheelchair can then have the satellite device with a wristband or lanyard to keep it with them. In the example shown in FIG. 26, each of the controller tag 2601 and the satellite tag 2605 have strap and mounting features 2611 and charging contacts 2615.

The smaller satellite tag 2605 can then be carried by the person associated with the controller device. Another application is that the controller is mounted to a pallet and then satellite tags are applied to or in boxes that should be associated with the pallet. The controller tag can then report the distance from the controller to all the satellite tags.

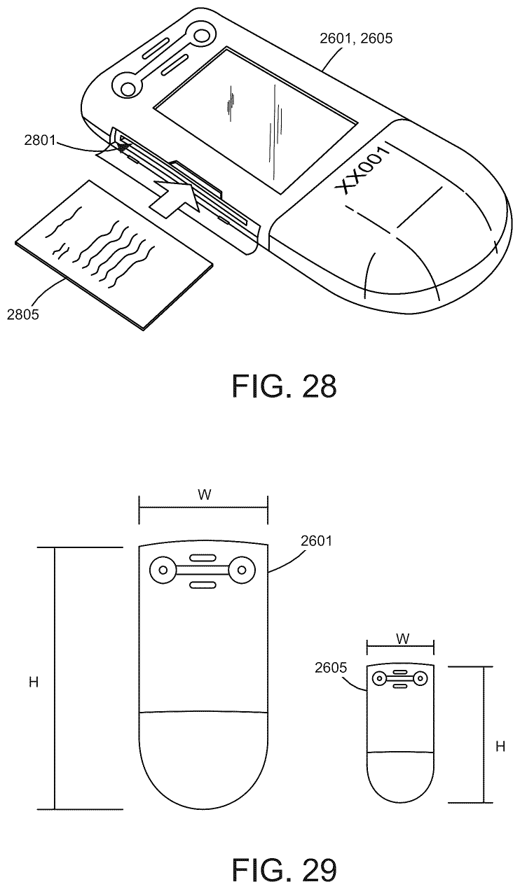

FIG. 28 shows an information slot 2801 for printed materials 2805 that is a feature for either tag shown in FIG. 26.

FIG. 29 shows an example design for the controller tag 2601 and the satellite tag 2605. For example, the controller tag 2601 may have a height H of about 100 mm and a width W of about 40 mm, and the satellite tag 2605 may have a height H of about 50 mm and a width W of about 20 mm.

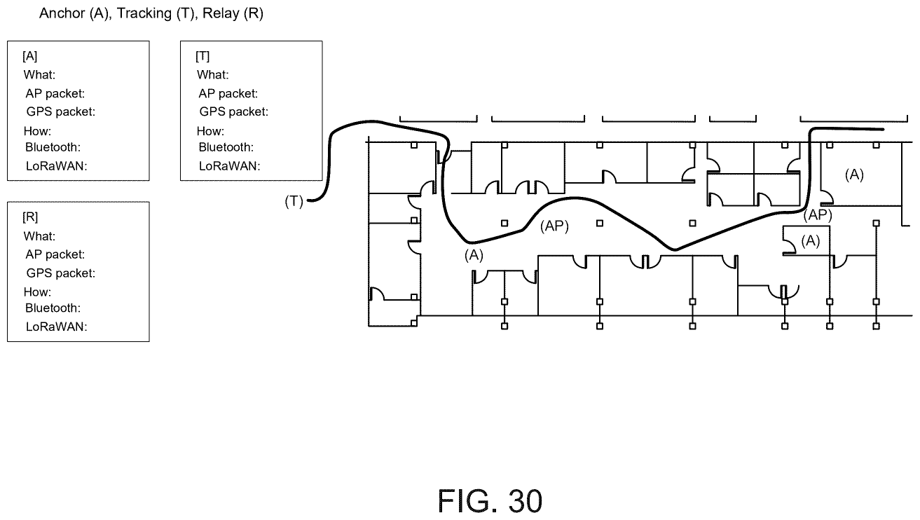

FIG. 30 shows the location of anchor tags and how they can complement the access points (AP) within a space. The space shows an office arca with an AP. This is good enough to indicate that a tag is in the area but may not be enough for determining if a tag is within a particular area. This example has an anchor (A) sensor at the conference rooms' entrances and at choke points for determining if a tag is close. The anchor devices have a better ranging system than the AP methods for Wi-Fi sniffing. The tracking tag (T) then travels through space along the solid line. The anchor A by the area entrance on the left detects that the tracking tag (T) has entered the area. A combination of the anchor tags and AP Wi-Fi sniffing can then resolve the tracking tag's location within the space. The additional anchors on the right monitor the choke points to determine if the tracking tag leaves the area or enters the conference room in the upper right corner of FIG. 30. The tag T will need the ability to have some understanding of its location in space. This will not necessarily be the full understanding of what exists in the cloud. There will be different personas given to a tag that is expected to stand in each space and one that roams across spaces.

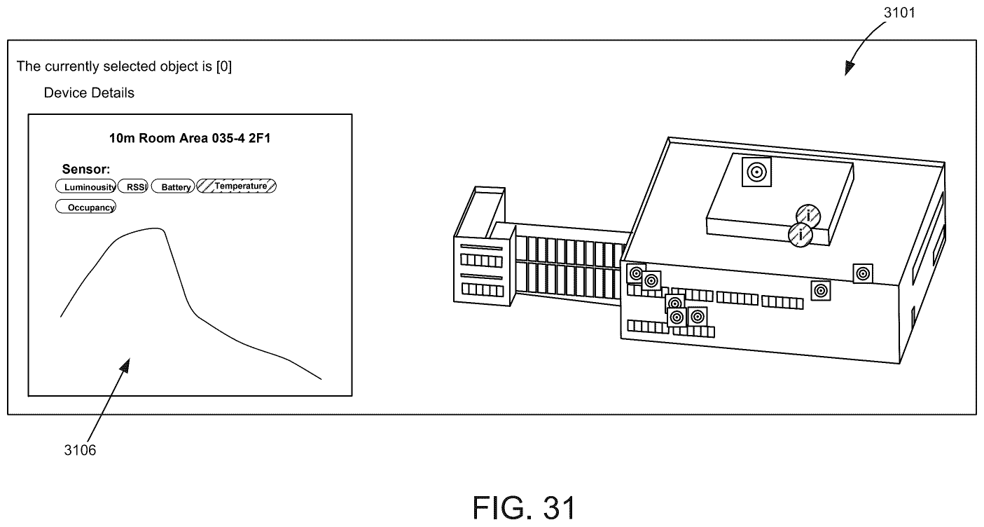

FIG. 30 shows the localization of a tag moving within a 2D map space. Many applications have the need for localization and connected data to be rendered with a space that has 3D aspects. FIG. 31 shows a 3D model 3101 of a building with a graph 3106 of the temperature within a room over a 24-hour time span. This same model can be used to show a location sensor tag's location to show what floor including how high the tag is located above the floor. For example, tags on boxes can be stacked quite high. It is useful to know if a box is low or high in the stack. This box stack can be represented in the 3D space to give the height needed to locate the correct box.

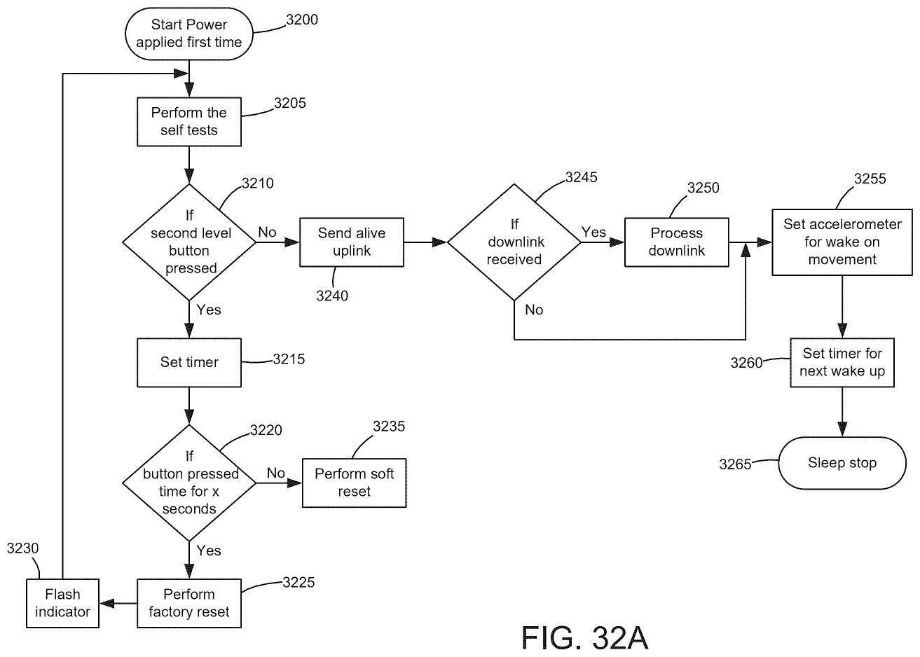

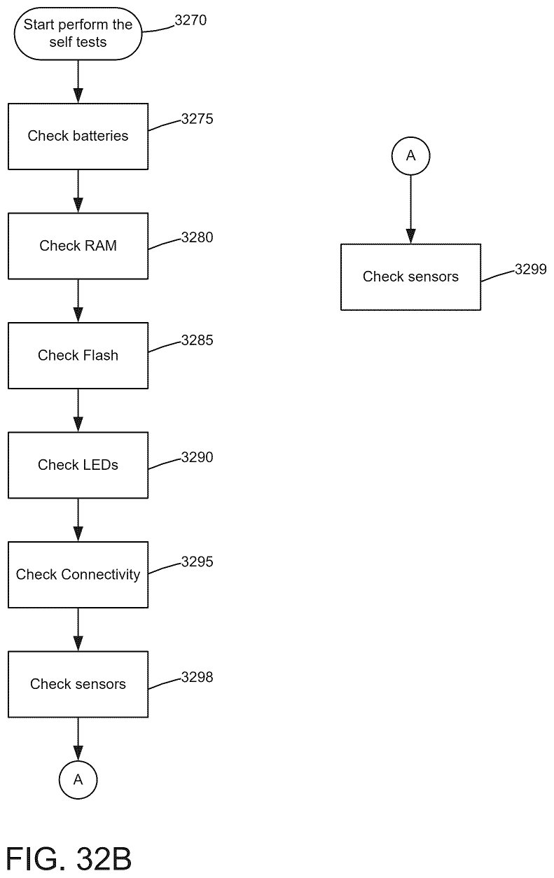

The operation of the location tag has many aspects of operation. The following section describes the basic programming functions to operate the location sensor 105 tag. FIG. 32 shows the process that is followed when the batteries are replaced or the first time the sensor is powered. At first power on or battery replacement at 3200, a step of testing is performed at 3205 to validate the expected operation of the major components of the device. The flowchart in FIG. 32B show the check steps. Next, at 3210, the devices determine if a user actuated the second level button by pressing. If not pressed, then the alive uplink is sent at 3240. If a downlink was received at 3245, then it is processed at 3250 before the accelerometer is armed to detect movement at 3255. The device then goes to sleep. A timer for the next wake up is set at 3260. When the timer expires, sleep mode stops at 3265. If the second level button is depressed at 3210, then a timer is set for x seconds (a predetermined length of time) at 3215. At 3220, if the button is still pressed after the timer, then a full factory reset is performed at 3225 that resets all commissioning information to the default state. After the factory reset, a flash indicator activates at 3230. If, at 3220, the button has been released before the timer expires, then a soft reset is performed at 3235.

In FIG. 32B, the check steps start at 3270. Batteries are checked at 3275, RAM is checked at 3280. Flash is checked at 3285, LEDs are checked at 3290, connectivity is checked at 3295, sensors are checked at 3298, and buttons are checked at 3299.

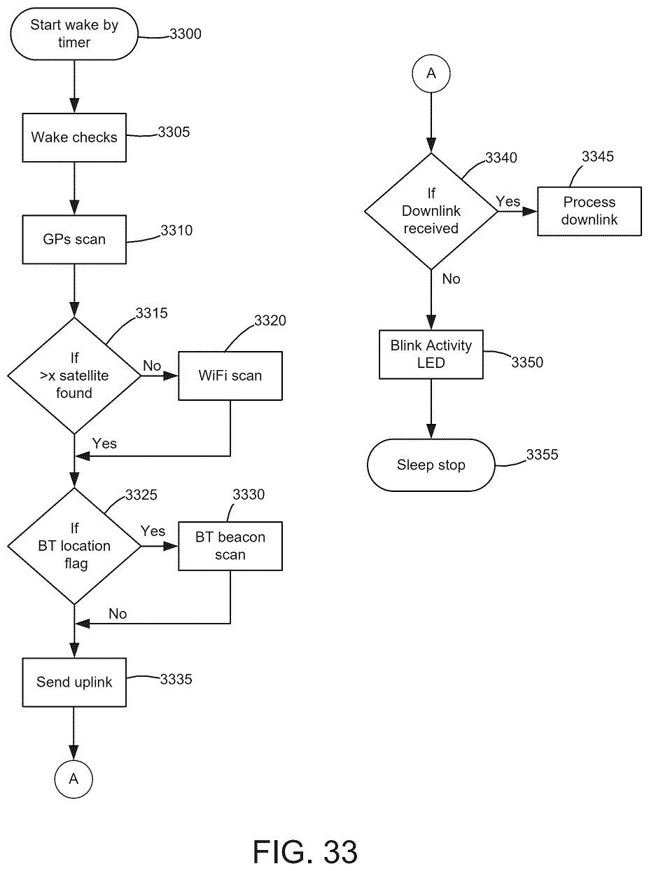

FIG. 33 shows a flowchart when the location sensor 105 awakes due to a timer alert. Wake by timer starts at 3300. The time initiates on a regular or scheduled time to determine the location and receive a downlink if available. After the operational check at 3305, the system performs a GPS scan at 3310 to determine if the location is outside and within the reception of enough satellites to perform a location fix. If it is determined at 3315 that there are not enough satellites in view, a Wi-Fi scan is performed at 3320 for what would probably be an indoor location. After the GPS and Wi-Fi scans, if the device is set up for finding Bluetooth beacons at 3325, then a Bluetooth scan is performed at 3330. The data found from these steps is then sent by an uplink to a central system for processing at 3335. For LoRaWAN or customer Bluetooth Low Energy, a downlink may be queued up for the device. If a downlink is received at 3340, then the downlink is processed at 3345. At the end of a cycle, a data action LED is blinked one time to indicate that the process has been completed at 3350. Sleep mode then stops at 3355.

The GPS, Wi-Fi sniffing and Bluetooth (BLE) systems resolve the location of devices, but other information relating to the sensor orientation in space may be helpful. The accelerometer is used to detect movement to respond to actions being applied to the object that the location sensor 105 is attached to. The accelerometer also reports the direction of gravity forces on the sensor when it is not accelerating with respect to earth at a fixed location. The gravity force is represented as a vector and indicates what part of a sensor is up or down. This is important because the operation can be affected by this orientation. For example, the antenna system may have a polarization that may impact the receive or transmit strength. Knowing this information can then be used to better estimate the range of the transmission or the distance estimate due to the signal strength.

Another function needed to help with orientation is a magnetometer that is used to measure the magnetic field and direction of the earth for a compass function. This is important to know how the location sensor 105 is rotated with respect to the surface of the earth. The combination of the accelerometer and magnetometer will indicate the orientation of the location sensor. If the relative position is known between the object and the location sensor, then the object's orientation is then known. This is important for objects being tracked like cars, trucks and trailers. This allows the rotation of the object to be displayed on a map. Take for example a tractor trailer that is parked. If the location of the sensor is known, then the orientation of the trailer is known too. This allows for the correct location and orientation to be shown on a map. Many businesses need to know how to easily identify a trailer's position to accurately manage a trailer's use in a large operation.

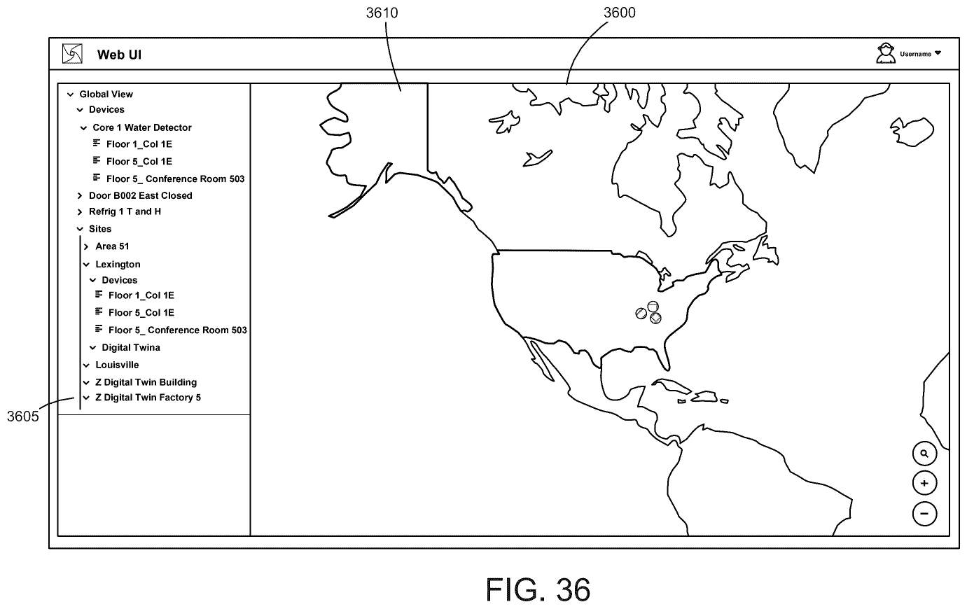

FIG. 36 shows a landing page 3600 to start the user interface displayed as a web page or application on a computer. This figure has an object tree 3605 shown on the left side that is a collection of sensor objects displayed in a hierarchy tree. The object tree 3605 has a global view of all devices and sites for the location devices 105. One skilled in the art would recognize that this representation may be used for any kind of sensor or device and is not limited to a location device 105. The range of devices can be sensing equipment, automation controllers, inventory of retail products or transportation vehicles. The tree is augmented with a 2D map 3610 that is zoomed to the level selected within the hierarchy. For example, selecting the global view zooms out the map to see several continents. If a site is selected, then the zoom level will be for an entire site definition with additional surrounding information for context.

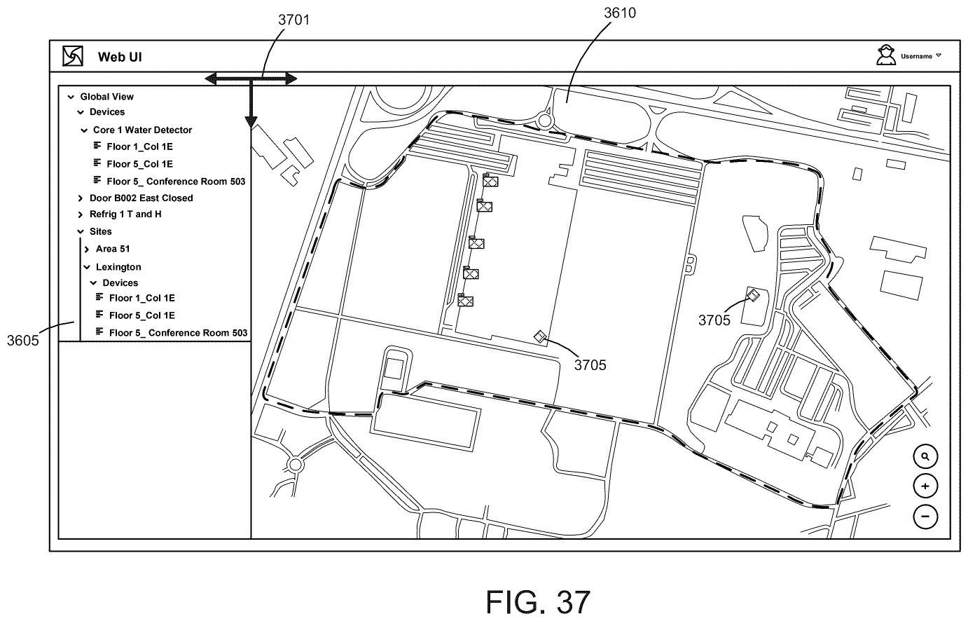

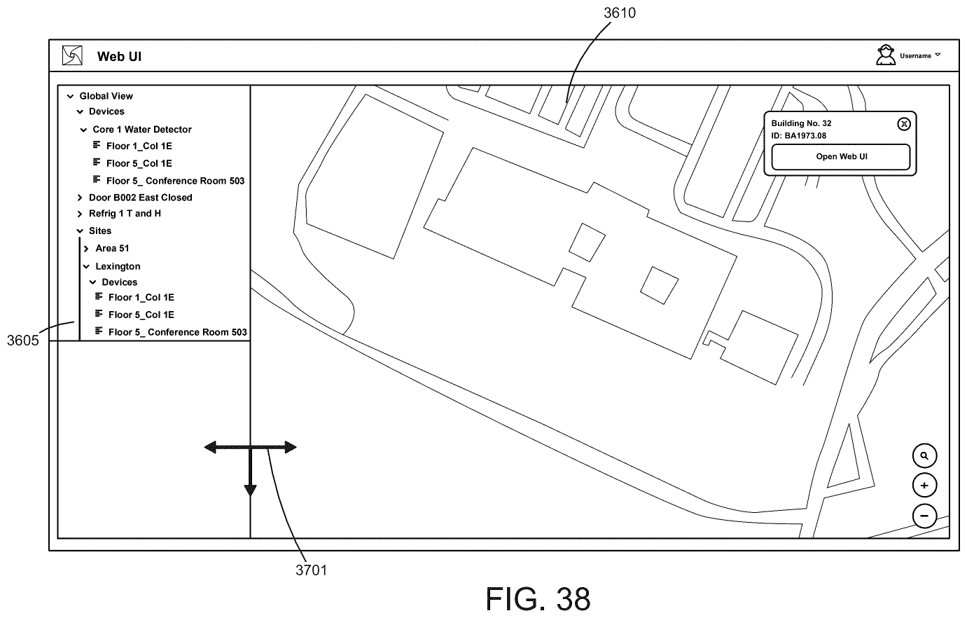

FIG. 37 shows a site being selected where the outline highlights the site and with the left pane sensor list 3605 and sensors represented by dots 3705. Note that the zoom level shows some surrounding area beyond the site for context. FIG. 38 shows a building complex of 3 individual buildings that are highlighted for a building set view. Again, the surrounding area is shown for context.

The panes are divided into two parts with the sizing icon 3701 shown between the tree and map sections. This icon with the arrows is used by dragging to resize the panes for convenience and ease of expanding the tree or map.

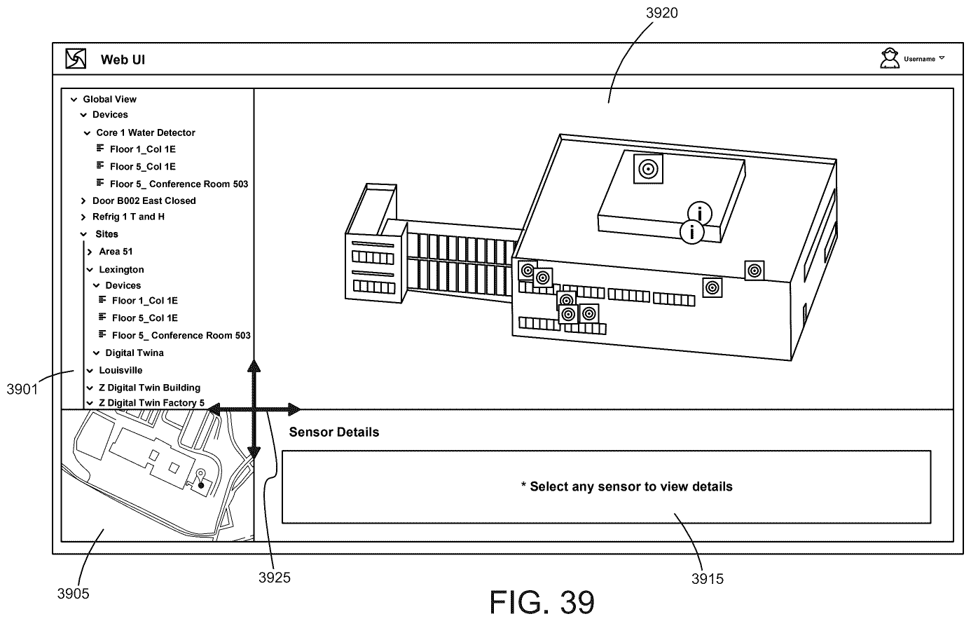

FIG. 39 adds two additional panes resulting in 4 quadrants with a visualization tree 3901, 2D map 3905, device detail table or graph 3915, and 3D digital twin 3920. These are separated by a resize icon 3925 that can be dragged to any location on the screen. This allows for any part or parts to be emphasized for the moment of interest.

### Sensor Location Visualization Process

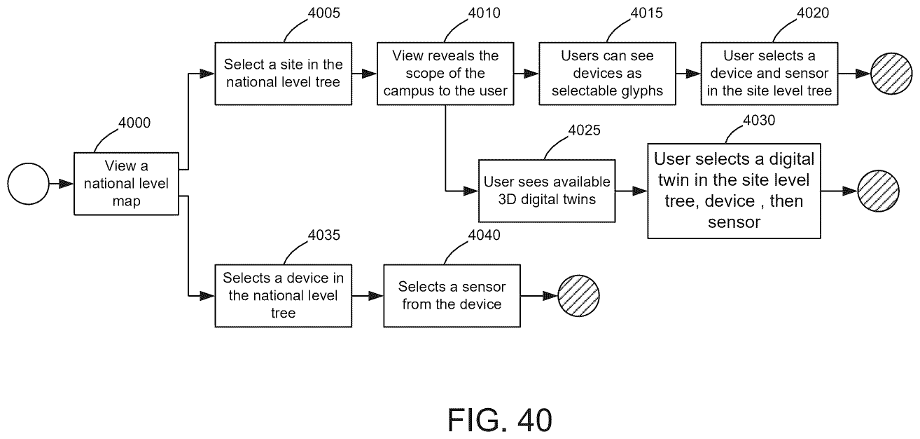

Users leveraging, viewing, and deriving business value from the sensor location requires a series of software processes that allow users to view, interact with, and action location data points seen from the devices, and sensor data values. FIG. 40 shows a user flow in a flowchart format that reveals the different branches that a user can navigate as they consume sensor locations and data. This process solves the problem of presenting devices, sensors, and digital twins to a user with the location, simplifying the navigation of those items in the different tree locations that can exist.

An example process is discussed as follows: After logging in, users view a national level map (at 4000) that displays sites and devices plotted on their actual location, with a tree-style navigation that shows these in a list. Additionally, the sites and devices are plotted on the map with points that can be selected. At 4005, the user selects a site in the national level tree that results in the map zooming in to the campus-level map view and additionally expands the site in the tree navigation to show the devices that are a child of that site, and digital twins that are a child of that site. At 4010, the site/campus level map view reveals the scope of the campus to the user with a bold map outline tracing the outer edges of the campus.

For the site level 2D map view, users can see devices as selectable glyphs (at 4015) that correlate to the physical location of the device. This location updates in real-time as new device location data are supplied to the user interface. At 4020, the user selects a device in the site level tree to cause a list of sensors to expand, and selecting a sensor will load a fly-out-modal that displays the sensor telemetry values. In this view, a user now knows where the sensor is located and has access to real-time telemetry values. For the site level 2D map view, the user can see available 3D digital twins (at 4025) displayed as bold outlines on the building or object for which there is a digital twin available. At 4030, the user then selects a digital twin in the site level tree. This causes a new window to load that has the original device tree, a 3D view of the digital twin, a 2D map that grounds the user to where they are in the campus, and a sensor data pane that will display real-time telemetry from the selected sensor.

At 4035, the user selects a device in the national level tree that results in the map zooming into the device location and expanding the device in the tree to show the sensors within the device. Finally, at 4040, the user selects a sensor from the device that causes a fly-out-modal to display the sensor telemetry values. In this view, a user now knows where the sensor is located and has access to real-time telemetry values.

One of the key aspects of a battery-operated sensor is to minimize the battery usage and one of the activities that uses the most battery power is sending wireless messages via LoRaWAN or Bluetooth. Referring back to FIG. 33, if the previous scan for location indicates that the position has not changed by a signal level range or GPS location, then the uplink can be suppressed if the last response was a short time ago. A wakeup on an accelerometer move can be suppressed for the uplink if the movement was less than some predetermined value. This is referred to as geofencing. The geofencing range will be stored in the central system and updated through a downlink.

Another embodiment adds location functionality to a package being shipped that has contents of high value that need to be monitored by some sensing method during shipping. Today, some cellular based devices have sensing capabilities that are prior art. These are not considered to be practical due to the cost of the cellular device and data plan. These can be collected but one problem is that customers may not take the time to return the cellular device after receiving the package. Bluetooth sensor devices are much lower cost, but they do not have the communication range necessary for many applications. This can be solved by breaking the system into parts that stay with a package and a returnable unit. For example, the package may include the sensor, and the returnable unit may include the more expensive long-range communications device.

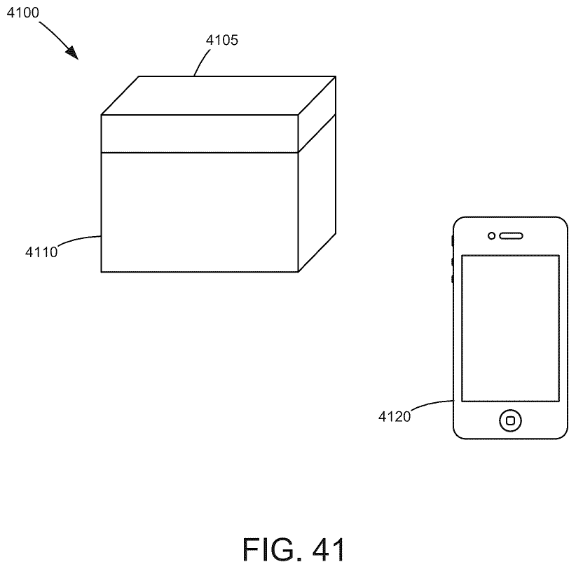

FIG. 41 shows a package 4100 that includes an upper unit 4105 that has the item that is shipped from a source to a destination and a lower unit 4110 that has the item to be shipped to a customer. This lower unit has the items and sensor with a short-range communications method like a Bluetooth (or BLE) device. One mode would have the sensor to communicate the temperature and humidity to the Bluetooth device in the lower unit 4110. The upper unit 4105 would then have a cellular or LoRaWAN device with a Bluetooth feature. The Bluetooth of the upper and lower units would then pair and communicate the information to the upper unit. This data would then be sent via the cellular or LoRaWAN to an edge computer or cloud computing system. The package is designed such that the upper unit 4105 is connected to the lower unit 4110 but can be separated by the shipper at the moment the lower unit 4110 is delivered at the destination. The shipper then returns the upper unit 4105 back to the processing location to be associated with the next lower unit to be sent to the next customers.

Example process steps are discussed follows:

The upper unit 4105 has the combination of the cellular (or LoRaWAN) device installed and associated with the package being sent. The lower unit 4110 has the combination Bluetooth and sensing device installed to monitor the payload being shipped to a customer. A mobile phone or other Bluetooth device 4120 communicates to the upper unit to associate with the lower unit. A return shipping label is added to the upper unit on a face that gets covered when the upper and lower units are attached to each other. The units are adhered to each other, and shipping labels are placed on an outer surface that associates the shipping label with the long-distance communications device. The unit is then shipped to the customer. When the package is dropped at the destination, the upper unit 4105 is removed from the lower unit 4110. The upper unit 4105 is scanned for the return path to the factory or processing location for association to another lower unit.

The lower unit 4110 still has the one time use sensor and Bluetooth (BLE) device that has a record of the full trip for location and sensor data. The customer can use a mobile phone or other Bluetooth device to read the full history of the package sensor and location data collected by the system.

The factory has access to all the data sent for the trip. If the customer allows communication through a cell phone app, then the destination data can be sent back to the manufacturer as well. This completes the needed documentation of the package conditions for the full process.

The foregoing description illustrates various aspects and examples of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

1. A system for location sensors to receive signals from satellites for geolocation, comprising:
a location sensor with a CPU and radio system able to receive satellite or Wi-Fi signals; and
a gateway that uses networking methods to communicate to a computer device that is connected to a power system, where raw data is sent from the location sensor to the gateway, wherein location information is described in spherical or linear coordinate systems that are provided on a mapping system.

2. The system of claim 1 where the computing system is an edge computer device at a premise location.

3. The system of claim 1 where the computing system is a server at a premise location.

4. The system of claim 1 where the computing system wherein the system is connected to the internet.

5. The system of claim 1 where the computing system wherein the system is isolated from any external systems.

6. The system of claim 2 where the edge computers communicate with cloud computer systems to keep long term records, backups, or give directions to the edge computer.

7. The system of claim 1, where the location sensor includes a flash indicator that can be seen in full sunlight.

8. A method for a user to access real-time telemetry values for a device, comprising:
viewing a national level map that displays sites and devices plotted on their actual location, with a tree-style navigation that shows the sites in a list;
selecting a site in the national level tree that results in the map zooming in to the campus-level map view, and additionally expands the site in the tree-style navigation to show the devices that are a child of that site, and digital twins that are a child of that site, where the site or campus level map view reveals the scope of the campus to the user with a bold map outline tracing the outer edges of the campus, and users can see devices as selectable glyphs that correlate to the physical location of the devices;
selecting a device in the site level tree to cause a list of sensors to expand, and selecting a sensor will load a fly-out-modal that displays the sensor telemetry values, where for the site level 2D map view, the user can see available 3D digital twins displayed as bold outlines on the building or object for which there is a digital twin available;
selecting a digital twin in the site level tree, which causes a new window to load that has the original device tree, a 3D view of the digital twin, a 2D map that grounds the user to where they are in the campus, and a sensor data pane that will display real-time telemetry from the selected sensor;
selecting a device in the national level tree that results in the map zooming into the device location and expanding the device in the tree to show the sensors within the device; and
selecting a sensor from the device that causes a fly-out-modal to display the sensor telemetry values, wherein a user now knows where the sensor is located and has access to real-time telemetry values.

9. A system, comprising:
an upper unit that has a cellular (or LoRaWAN) device installed that is associated with a package being sent;
a lower unit that has a sensing device installed to monitor the payload being shipped to a customer;
a cell phone or other device that communicates with the upper unit to associate with the lower unit; and
a return shipping label added to the upper unit on a face that gets covered when the upper and lower units are attached to each other, wherein the units are adhered to each other, and shipping labels are placed on an outer surface that associates the shipping label with the long-distance communication device, and w when the package arrives at the destination, the upper unit may be removed from the lower unit and scanned for the return path to the factory or processing location for association to another lower unit.
